(19) United States
(12) Patent Application Publication
(10) Pub. No.: US 2025/0067516 A1
(43) Pub. Date: Feb. 27, 2025

(54) PROCESSES AND APPARATUSES FOR HEATING A PROCESS FLUID

(71) Applicant: UOP LLC, Des Plaines, IL (US)

(72) Inventors: Amit Munjal, Haryana (IN); Chintan Surendra Shah, Haryana (IN); Sudipta Kumar Ghosh, Haryana (IN)

(21) Appl. No.: 18/456,053

(22) Filed: Aug. 25, 2023

Related U.S. Application Data
(60) Provisional application No. 63/382,147, filed on Nov. 3, 2022.

(51) Int. Cl. F28D 7/06

(52) U.S. Cl. CPC F28D 7/06; F28D 2021/0059

(57) ABSTRACT

Processes and apparatuses for heating a process fluid. The process fluid flow through a convection section and then a radiant section. The radiant section produces heat and flue gas from the combustion of the fuel. The flue gases flow to the convection section to provide the heat in the convection section. The conduits in the convection section are straight. All of the fluid that passes through the convection section also passes through the radiant section.

### RELATED APPLICATIONS

This application claims priority to U.S. Provisional Patent Application Ser. No. 63/382,147 filed on Nov. 3, 2022, the entirety of which is incorporated herein by reference.

### FIELD OF THE INVENTION

This invention relates generally to processes and apparatuses for heating a process fluid, and more specifically to processes and apparatuses for processes fluids which contain hydrocarbons that are reactants in one or more desired chemical reactions.

### BACKGROUND OF THE INVENTION

Fired heaters are common process units in chemical plants and heat process streams to reaction temperatures. The fired heaters have a radiant section having one or more burners configured to provide heat to process fluid in tubes extending through the radiant section. The process streams are heated which allows for endothermic reactions associated with the hydrocarbons in the process fluid to occur.

A convection section of the fired heater is located adjacent to the radiant section, usually above, and receives hot flue gases from the radiant section. The convection section is typically used for steam generation in a way to improve overall heater efficiency by transferring heat to water in tubes extending through the convection section. However, the heat input to the heaters is based on the process heating required in the radiant section. Thus, in some heaters which produce a large amount of heat and consume large amounts of fuel, the amount of heat generated far exceeds the heat needed to generate steam. This excess heat is lost or otherwise not utilized.

Accordingly, while the utilization of the flue gases to generate steam improves the overall heater efficiency, it would be desirable to more effectively and efficiently use the convection section of the fired heater to improve the primary fuel efficiency and, in turn, reduce the fuel firing.

### SUMMARY OF THE INVENTION

One or more apparatuses and processes have been invented in which the heat of the flue gases in the convection section can be utilized for process heating instead of steam generation. It would be expected that the pressure drop associated with passing the process fluid through the convection section would not allow for such a design. However, it has been surprisingly found that there are arrangements which allow process fluid to be heated in the convection section (and radiant section) without being adversely impacted by pressure drop. The utilization of the convection section heating the process fluid will allow the size of the radiant section to be reduced. As would be appreciated this lowers the fuel consumption and carbon dioxide production. Such benefits can be achieved in new fired heaters or in revamped fired heaters.

Therefore, the present invention may be characterized, in at least one aspect, as providing an apparatus for heating a process fluid. The apparatus includes: a radiant section having one or more burners configured to provide heat and flue gas; a convection section disposed above adjacent the radiant section, the convection section configured to receive the flue gas from the radiant section; a convection conduit passing through the convection section and configured to receive a process fluid and transfer heat to the process fluid; and, a radiant conduit passing through the radiant section and configured to receive the process fluid and transfer heat to the process fluid. The convection conduit and the radiant conduit are arranged in series such that all of the process fluid passing through the convection conduit passes through the radiant conduit.

The radiant conduit may be a multi-pass coil conduit.

The convection conduit may be a straight conduit with no bends.

A plurality of parallel convection conduits may be provided in which each convection conduit passes through the convection section and is configured to receive the process fluid and transfer heat to the process fluid.

The apparatus may also include a first convection manifold and a second convection manifold. The plurality of parallel convection conduits may extend between the first convection manifold and the convection second manifold.

The apparatus may also include a bypass conduit configured to bypass a portion of the process fluid around the convection section. A first radiant manifold and a second radiant manifold may also be provided. The radiant conduit may extend between the first radiant manifold and the second radiant manifold. The first radiant manifold may be configured to receive process fluid from the convection conduit. The first radiant manifold may also be configured to receive process fluid from the bypass conduit.

The radiant section may have a plurality of heating zones with each heating zone being operated at a temperature independent of a temperature of the other heating zones. The convection conduit may be arranged such that an inlet of the convection conduit is above a heating zone having a higher temperature compared with a heating zone below an outlet of the convection conduit.

In one or more aspects the present invention may be characterized, generally, as providing a method for heating a process fluid by: combusting fuel in a radiant section of an apparatus to produce heat and flue gas; passing a process fluid through a convection section to heat the process fluid, the convection section receiving the flue gas from the radiant section; and passing the process fluid through the radiant section to heat the process fluid, wherein the process fluid that passes through the radiant section has passed through the convection section.

The method may also include bypassing a portion of the process fluid around the convection section. The portion of the process fluid that bypassed the convection section may be combined with the process fluid that was passed to the convection section.

The method may also include adjusting an amount of the portion of the process fluid that bypasses the convection section.

The convection section may include at least one convection conduits, which may be a straight conduit. The radiant section may include a plurality of heating zones with each heating zone being operated at a temperature independent of a temperature of the other heating zones. The at least one convection conduit may be arranged such that an inlet of the at least one convection conduit is above a heating zone having a higher temperature compared with a heating zone below an outlet of the at least one convection conduit.

The radiant section may include at least one convection conduit that may be a multi-pass coil conduit.

The process fluid may be from a hydrocarbon reforming zone.

Additional aspects, embodiments, advantages, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

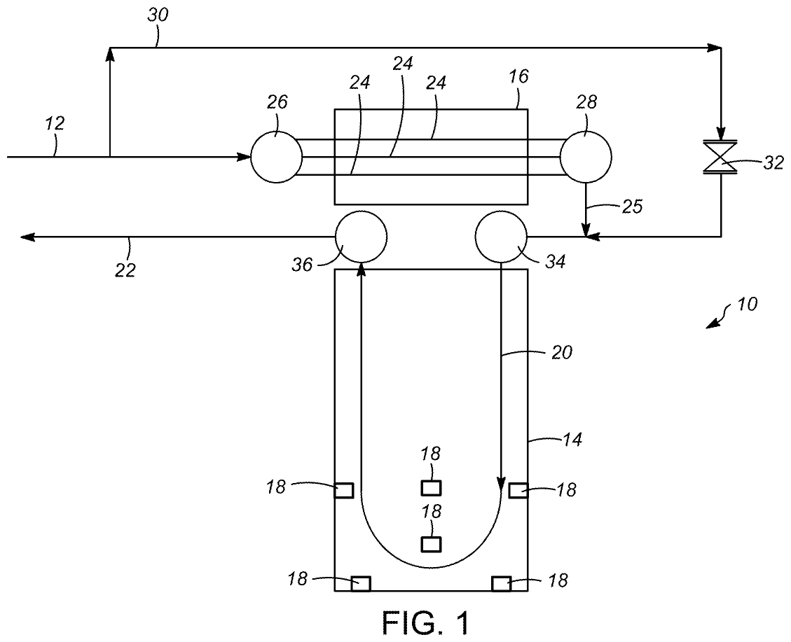

FIG. 1 is a schematic diagram of an apparatus for heating a process fluid according to one or more aspects of the present invention; and,

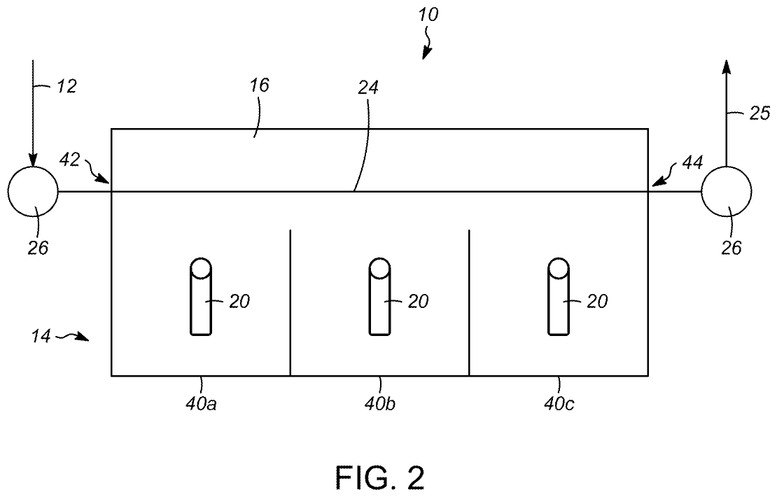

FIG. 2 is another schematic diagram of an apparatus for heating a process fluid according to one or more aspects of the present invention.

### DETAILED DESCRIPTION OF THE INVENTION

As mentioned above, the present invention is directed at methods and devices which use both a radiant section and a convection section to heat process fluid. This is a more direct way of heating process fluid. In addition to increased efficiencies, this allows for the heaters to be smaller, consume less fuel, and produce less carbon dioxide. Additionally, the present apparatuses and methods reduce the pressure drop associated with heating the process fluid such that the heaters may be utilized in processes which have a lower operating pressure (and higher temperature). Thus, yield of the desired chemical reaction is not impacted.

With these general principles in mind, one or more embodiments of the present invention will be described with the understanding that the following description is not intended to be limiting.

As shown in FIG. 1, an apparatus 10, such as a fired heater or charge heater, for heating a process fluid 12 includes a radiant section 14 and convection section 16. While the process fluid 12 is not necessarily limited to a particular desired reaction, it is thought that the present invention is particularly advantageous in reforming, dehydrogenation, isomerization, disproportionation and transalkylation, and conversion of alcohols to hydrocarbon fuels.

The radiant section includes one or more burners 18 which receive oxygen and a fuel, such as fuel gas and/or fuel oil, allow the combustion of the fuel, and produce heat and flue gas (as well as a flame). The heat in the radiant section is used to heat the process fluid 12 which is contained in one or more radiant conduits 20 passing through the radiant section 14 and provide a heated process fluid 22.

wherein the radiant conduit comprises a multi-pass coil conduit which include bends or turns to increases the residence time of the process fluid within the radiant section 14. For example, the multi-pass coil conduit may be a U coil, arbor coil, I, Double I, W coil, twin U, serpentine, helical or other such configurations.

The convection section 16 is disposed adjacent to the radiant section 14 so that the hot flue gas from the radiant section 14 is received in the convection section 16. For example, the convection section 16 may be above or laterally beside the radiant section 14.

One or more convection conduits 24 extend through the convection section 16 and, unlike conventional designs, the convection conduits 24 are configured to receive the process fluid 12 and transfer heat from the flue gas to the process fluid 12 and provide a preheated process fluid 25. It is contemplated that a plurality of parallel convection conduits 24 are utilized. In order to reduce any pressure drop, the convection conduit(s) 24 preferably is a straight conduit that contains no bends.

The convection conduit 24 and the radiant conduit 20 are arranged in series such that all of the process fluid 12 passing through the convection conduit 24, i.e., all of the preheated process fluid 25, and thus the convection section 16, passes through the radiant conduit 20, and thus the radiant section 14, before being recover as the heated process fluid 22.

The apparatus 10 may further include a first convection manifold 26 and a second convection manifold 28 with the convection conduits 24 extending therebetween. The first convection manifold 26 may be an inlet convection manifold which distributes the process fluid 12 to the convection conduits 24. The second convection manifold 28 may be an outlet convection manifold which provides the preheated process fluid 25.

In order to allow for temperature control associated with the system, and to further address or reduce pressure drop concerns, a bypass conduit 30 may be provided. The bypass conduit allows for a portion of the process fluid 12 to bypass the convection section 16. A valve 32, or other device, like an orifice or turbine, may be provided to control or adjust the flow of fluid in the bypass conduit 30.

The apparatus 10 may also include a first radiant manifold 34 and a second radiant manifold 36 with the radiant conduit(s) 20 extending therebetween. The first radiant manifold 34 may be an inlet radiant manifold which allows the process fluid 12 from the bypass conduit 30 and the preheated process fluid 25 from the convection section 16 to mix and be distributed to the radiant conduits 20. The second radiant manifold 36 may be an outlet radiant manifold which provides the heated process fluid 22 from the apparatus 10. Additionally, the sizes of the radiant manifolds 34. 36 can be adjusted to reduce hot volume and reduce the need for an auxiliary heater.

Turning to FIG. 2, the radiant section 14 of the apparatus 10 includes a plurality of heating zones 40a, 40b, 40c. As should be appreciated, the number of depicted heating zones 40a, 40b, 40c is merely exemplary. Each of the heating zones 40a, 40b, 40c has radiant conduits 20 which receive process fluid 12; however, the process fluid maybe different. For example, one heating zone 40a may be a charge heater and the process fluid 12 passed thereto may be a feed stream. A second heating zone 40b may be a first interstage heater and the process fluid 12 passed thereto may be effluent from a first reactor. A third heating zone 40c may be a second interstage heater and the process fluid 12 passed thereto may be effluent from a second reactor. Each heating zone 40a, 40b, 40c is operated at a temperature independent of a temperature of the other heating zones 40a, 40b, 40c. Thus, all of the heating zones 40a, 40b, 40c may have a different operating temperature. In order to reduce concerns with metal catalyzed coking in the convection conduits 24, the convection conduit 24 is arranged such that an inlet 42 of the convection conduit 24 is above a heating zone 40a having a higher temperature compared with a heating zone 40c below an outlet 44 of the convection conduit 24. In other words, the flow through the convection section 16 is arranged from hot to cold relative to the heating zones 40a, 40b, 40c below the convection conduits 24. In such a radiant section, all of the preheated process fluid 25 is typically passed to one of the heating zones 40a, 40b, 40c in the radiant section 14.

With reference to both FIGS. 1 and 2, exemplary processes for heating the process fluid 12 will be described.

Fuel, like fuel gas and/or fuel oil, is combusted in the radiant section 14 the apparatus 10 produce heat and flue gas. At least a portion of the process fluid 12 is passed through the convection section 16 to provide the preheated process fluid 25.

In order to provide heat to the process fluid in the convection section 16, the convection section 16 receives flue gas from the radiant section 14. All of the process fluid that passed through the convection section 16, i.e., the preheated process fluid 25, is passed to the radiant section 14.

A portion of the process fluid 12 may bypass around the convection section 16 in the bypass conduit 30. Accordingly, the portion of process fluid 12 that bypassed the convection section 16 may be combined with the preheated process fluid 25. The amount of process fluid 12 passing through the bypass conduit 30 may be adjusted by, for example, adjusting the valve 32 in the bypass conduit 30.

As discussed above, these provides benefits by more efficiently utilizing the heat produced by the combustion of fuel in the radiant section. This may lead to smaller heaters and reduced fuel consumption and carbon dioxide output. Additionally, further features of the present invention reduce concerns with pressure drop and metal catalyzed coking.

### EXPERIMENTS

In theoretical comparisons based on the using the convection section to heat a process stream for an 87,000 BPSD process, the processes and apparatuses using the present invention showed a 21% reduction in carbon dioxide emissions. In a process with 50% of the 87,000 BPSD, the present processes showed a reduced of 22.5% reduction in carbon dioxide reduction.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### SPECIFIC EMBODIMENTS

While the following is described in conjunction with specific embodiments, it will be understood that this description is intended to illustrate and not limit the scope of the preceding description and the appended claims.

A first embodiment of the invention is an apparatus for heating a process fluid, the apparatus comprising a radiant section having one or more burners configured to provide heat and flue gas; a convection section disposed adjacent the radiant section, the convection section configured to receive the flue gas from the radiant section; a convection conduit passing through the convection section and configured to receive a process fluid and transfer heat to the process fluid; and, a radiant conduit passing through the radiant section and configured to receive the process fluid and transfer heat to the process fluid, wherein the convection conduit and the radiant conduit are arranged in series such that all of the process fluid passing through the convection conduit passes through the radiant conduit. An embodiment of the invention is one, any or all of prior embodiments in this paragraph up through the first embodiment in this paragraph, wherein the radiant conduit comprises a multi-pass coil conduit. An embodiment of the invention is one, any or all of prior embodiments in this paragraph up through the first embodiment in this paragraph, wherein the convection conduit comprises a straight conduit with no bends. An embodiment of the invention is one, any or all of prior embodiments in this paragraph up through the first embodiment in this paragraph, comprising a plurality of parallel convection conduits, each convection conduit passing through the convection section and configured to receive the process fluid and transfer heat to the process fluid. An embodiment of the invention is one, any or all of prior embodiments in this paragraph up through the first embodiment in this paragraph, further comprising a first convection manifold and a second convection manifold, the plurality of parallel convection conduits extending between the first convection manifold and the convection second manifold. An embodiment of the invention is one, any or all of prior embodiments in this paragraph up through the first embodiment in this paragraph, further comprising a bypass conduit configured to bypass a portion of the process fluid around the convection section. An embodiment of the invention is one, any or all of prior embodiments in this paragraph up through the first embodiment in this paragraph, further comprising a first radiant manifold and a second radiant manifold, the radiant conduit extending between the first radiant manifold and the second radiant manifold. An embodiment of the invention is one, any or all of prior embodiments in this paragraph up through the first embodiment in this paragraph, wherein the first radiant manifold is configured to receive process fluid from the convection conduit. An embodiment of the invention is one, any or all of prior embodiments in this paragraph up through the first embodiment in this paragraph, wherein the first radiant manifold is further configured to receive process fluid from the bypass conduit. An embodiment of the invention is one, any or all of prior embodiments in this paragraph up through the first embodiment in this paragraph, wherein the radiant section has a plurality of heating zones, each heating zone operated at a temperature independent of a temperature of the other heating zones. An embodiment of the invention is one, any or all of prior embodiments in this paragraph up through the first embodiment in this paragraph, wherein the convection conduit is arranged such that an inlet of the convection conduit is above a heating zone having a higher temperature compared with a heating zone below an outlet of the convection conduit.

A second embodiment of the invention is a method for heating a process fluid, the method comprising combusting fuel gas and/or fuel oil in a radiant section of an apparatus to produce heat and flue gas; passing a process fluid through a convection section to heat the process fluid, the convection section receiving the flue gas from the radiant section; passing the process fluid through the radiant section to heat the process fluid, wherein the process fluid that passes through the radiant section has passed through the convection section. An embodiment of the invention is one, any or all of prior embodiments in this paragraph up through the second embodiment in this paragraph, further comprising bypassing a portion of the process fluid around the convection section. An embodiment of the invention is one, any or all of prior embodiments in this paragraph up through the second embodiment in this paragraph, further comprising combining the portion of the process fluid that bypassed the convection section with the process fluid that was passed to the convection section. An embodiment of the invention is one, any or all of prior embodiments in this paragraph up through the second embodiment in this paragraph, further comprising adjusting an amount of the portion of the process fluid that bypasses the convection section. An embodiment of the invention is one, any or all of prior embodiments in this paragraph up through the second embodiment in this paragraph, wherein the convection section comprises at least one convection conduit, the at least one convection conduit comprising a straight conduit. An embodiment of the invention is one, any or all of prior embodiments in this paragraph up through the second embodiment in this paragraph, wherein the radiant section has a plurality of heating zones, each heating zone operated at a temperature independent of a temperature of the other heating zones. An embodiment of the invention is one, any or all of prior embodiments in this paragraph up through the second embodiment in this paragraph, wherein the at least one convection conduit is arranged such that an inlet of the at least one convection conduit is above a heating zone having a higher temperature compared with a heating zone below an outlet of the at least one convection conduit. An embodiment of the invention is one, any or all of prior embodiments in this paragraph up through the second embodiment in this paragraph, wherein the radiant section comprises at least one convection conduit, the at least one convection conduit comprising a multi-pass coil conduit. An embodiment of the invention is one, any or all of prior embodiments in this paragraph up through the second embodiment in this paragraph, wherein the process fluid is from a hydrocarbon reforming zone.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An apparatus for heating a process fluid, the apparatus comprising:
a radiant section having one or more burners configured to provide heat and flue gas;
a convection section disposed adjacent the radiant section, the convection section configured to receive the flue gas from the radiant section;
a convection conduit passing through the convection section and configured to receive a process fluid and transfer heat to the process fluid; and,
a radiant conduit passing through the radiant section and configured to receive the process fluid and transfer heat to the process fluid,
wherein the convection conduit and the radiant conduit are arranged in series such that all of the process fluid passing through the convection conduit passes through the radiant conduit.

2. The apparatus of claim 1, wherein the radiant conduit comprises a multi-pass coil conduit.

3. The apparatus of claim 1, wherein the convection conduit comprises a straight conduit with no bends.

4. The apparatus of claim 1, comprising a plurality of parallel convection conduits, each convection conduit passing through the convection section and configured to receive the process fluid and transfer heat to the process fluid.

5. The apparatus of claim 1, further comprising:
a first convection manifold and a second convection manifold, the plurality of parallel convection conduits extending between the first convection manifold and the convection second manifold.

6. The apparatus of claim 1, further comprising:
a bypass conduit configured to bypass a portion of the process fluid around the convection section.

7. The apparatus of claim 6, further comprising:
a first radiant manifold and a second radiant manifold, the radiant conduit extending between the first radiant manifold and the second radiant manifold.

8. The apparatus of claim 7, wherein the first radiant manifold is configured to receive process fluid from the convection conduit.

9. The apparatus of claim 8, wherein the first radiant manifold is further configured to receive process fluid from the bypass conduit.

10. The apparatus of claim 1, wherein the radiant section has a plurality of heating zones, each heating zone operated at a temperature independent of a temperature of the other heating zones.

11. The apparatus of claim 10, wherein the convection conduit is arranged such that an inlet of the convection conduit is above a heating zone having a higher temperature compared with a heating zone below an outlet of the convection conduit.

12. A method for heating a process fluid, the method comprising:
combusting fuel in a radiant section of an apparatus to produce heat and flue gas;
passing a process fluid through a convection section to heat the process fluid, the convection section receiving the flue gas from the radiant section;
passing the process fluid through the radiant section to heat the process fluid, wherein the process fluid that passes through the radiant section has passed through the convection section.

13. The method of claim 12, further comprising:
bypassing a portion of the process fluid around the convection section.

14. The method of claim 13, further comprising:
combining the portion of the process fluid that bypassed the convection section with the process fluid that was passed to the convection section.

15. The method of claim 13, further comprising:
adjusting an amount of the portion of the process fluid that bypasses the convection section.

16. The method of claim 12, wherein the convection section comprises at least one convection conduit, the at least one convection conduit comprising a straight conduit.

17. The method of claim 16, wherein the radiant section has a plurality of heating zones, each heating zone operated at a temperature independent of a temperature of the other heating zones.

18. The method of claim 17, wherein the at least one convection conduit is arranged such that an inlet of the at least one convection conduit is above a heating zone having a higher temperature compared with a heating zone below an outlet of the at least one convection conduit.

19. The method of claim 12, wherein the radiant section comprises at least one convection conduit, the at least one convection conduit comprising a multi-pass coil conduit.

20. The method of claim 12, wherein the process fluid is from a hydrocarbon reforming zone.
